(19) United States
(12) Patent Application Publication
(10) Pub. No.: US 2026/0262565 A1
(43) Pub. Date: Sep. 10, 2026

(54) EFFICIENT SPOT SPRAYING OF AGROCHEMICALS

(71) Applicant: Ecorobotix SA, Yverdon-les-Bains (CH)

(72) Inventors: Steve TANNER, Yverdon-les-Bains (CH); Florent DEFAY, Yverdon-les-Bains (CH)

(21) Appl. No.: 19/661,129

(22) Filed: Apr. 28, 2026

Related U.S. Application Data
(63) Continuation of application No. PCT/EP2024/077426, filed on Sep. 30, 2024.

(30) Foreign Application Priority Data
Nov. 2, 2023 (GB) GB2316812.3

(51) Int. Cl. A01C 23/00; A01C 23/04; A01M 7/00

(52) U.S. Cl. CPC A01C 23/007; A01C 23/047; A01M 7/0042

(57) ABSTRACT

Described herein is a method for operating a control system of a spray assembly to apply agrochemicals. The method includes identifying a target object and a proximate avoid object, and defining a pattern of spot sprays based on their placement and nozzle opening duration, such that a maximum non-zero dose to the avoid object is not exceeded and at least a minimum dose per unit area is applied to a defined portion of the target object. Each spot spray has a non-homogeneous two-dimensional liquid distribution influenced by nozzle-to-target distance, forward speed of the spray assembly, and nozzle opening duration. The method further includes generating control signals for an array of nozzles according to the defined pattern and outputting the control signals to the spray assembly.

### CROSS-REFERENCE

This application is a Continuation application of International Application No. PCT/EP2024/077426, filed on Sep. 30, 2024, which claims the benefit of Great Britain Patent Application No. GB2316812.3, filed on Nov. 2, 2023, each of which is incorporated herein in its entirety.

### TECHNICAL FIELD

The present invention relates to control of spray apparatus for spot spraying of plants with agrochemicals.

### BACKGROUND

Agrochemicals, whether to promote growth (e.g. fertilisers), inhibit growth (e.g. herbicides) or prevent diseases or plagues (fungicides, insecticides, etc.), are typically applied to plants in liquid form using spraying. The agrochemicals are sprayed through nozzles which may be mounted on a spray bar. The spray bar may be mounted on a vehicle (e.g. a tractor or robot) or mounted on a device that is towed by a vehicle. Continuous or broadcast spraying involves spraying agrochemicals everywhere and the nozzles are in continuous operation. In contrast, spot spraying applies droplets of liquids on specific and predetermined locations through the use of valves (e.g. electromechanically controlled valves) which can switch the flow of the agrochemical on and off rapidly.

Use of continuous spraying is often inefficient since the agrochemicals are sprayed where they are not needed (e.g. onto bare soil) and as well as increasing costs, this increases chemical residues in the soils which can have various impacts including damaging biodiversity and an increased likelihood of phytotoxicity for the sprayed crop plants leading to yield losses. Spot spraying can significantly reduce the amount of agrochemical that is applied. This increases efficiency (since the agrochemical is only applied where it is needed), reduces the environmental impact (e.g. less chemical residues in soils and water, reduced carbon emissions due to reduced fabrication and transport of liquid agrochemicals), reduces use of water, and improves yield.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Described herein is a method of operation of a control system for spraying agrochemicals using a spray assembly. The method comprises identifying a target object and a proximate avoid object and then defining by their placement and opening duration, a pattern of spot sprays such that a maximum, non-zero, dose applied to the proximate avoid object is not exceeded and at least a minimum dose per unit area is applied to a pre-defined proportion of the target object. Each spot spray is defined by a non-homogeneous two-dimensional liquid spatial distribution modified by the distance from the nozzle to the target object, the forward speed of the spray assembly and the opening duration of the nozzle. Having defined the pattern, the method comprises generating control signals for the array of nozzles according to the pattern of spot sprays and outputting the control signals to the spray assembly.

A first aspect provides a method of operation of a spot spray control system for spraying agrochemicals on target objects using a spray assembly and minimising spraying on avoid objects, the spray assembly comprising an array of nozzles, wherein an opening time and opening duration of the nozzles can be individually controlled and the method comprising: (i) identifying a target object and a proximate avoid object; (ii) defining by their placement and opening duration, a pattern of spot sprays such that a maximum, non-zero, dose applied to the proximate avoid object is not exceeded and at least a minimum dose per unit area is applied to a pre-defined proportion of the target object, wherein each spot spray is defined by a non-homogeneous two-dimensional liquid spatial distribution modified by a distance from the nozzle to the target object, the forward speed of the spray assembly and the opening duration of the nozzle; (iii) generating control signals for the array of nozzles according to the pattern of spot sprays; and (vi) outputting the control signals to the spray assembly.

Defining the pattern of spot sprays may comprise, for each target object: placing a first spot spray as close as possible to the proximate avoid object without exceeding the maximum, non-zero, dose on the proximate avoid object; placing one or more additional spot sprays as close as possible to the proximate avoid object to form a continuous spray region of at least the minimum dose over a part of the target object whilst not exceeding the maximum, non-zero, dose on the proximate avoid object; and if the part of the target object covered by the continuous spray region is less than the pre-defined proportion of the target object, placing one or more further spot sprays such that the continuous spray region of at least the minimum dose extends over the pre-defined proportion of the target object.

Defining the pattern of spot sprays may comprise: determining a spray size and stride such that when the spot sprays are staggered, no area will receive less than the minimum dose; generating a plurality of resultant patterns, each resultant pattern corresponding to a different one of a plurality of a plurality of candidate starting positions for an array of spot sprays; and selecting a resultant pattern from the plurality of resultant patterns that minimizes wastage of agrochemicals, wherein each resultant pattern is generated by: for each target object, generating an array portion by: positioning an array of spot sprays at the determined size and stride over an entire spray window, starting at the candidate starting position; removing all spot sprays from the array that do not touch the target object; removing spot sprays until the proximate avoid object receives less than the maximum, non-zero dose; and removing any spot sprays that are not necessary to reach the minimum dose over the pre-defined proportion of the target object; and combining the array portions for each of the target objects.

Defining the pattern of spot sprays may comprise: determining a spray size and stride such that when the spot sprays are staggered, no area will receive less than the minimum dose; and for each target object, generating a plurality of array portions, each array portion corresponding to a different one of a plurality of a plurality of candidate starting positions for an array of spot sprays; and selecting an array portion from the plurality of array portions that minimizes wastage of agrochemicals, wherein each array portion is generated by: positioning an array of spot sprays at the determined size and stride over an entire spray window, starting at the candidate starting position; removing all spot sprays from the array that do not touch the target object; removing spot sprays until the proximate avoid object receives less than the maximum, non-zero dose; and removing any spot sprays that are not necessary to reach the minimum dose over the pre-defined proportion of the target object.

The maximum, non-zero, dose may be a maximum, non-zero, dose per unit area.

The method may further comprise: determining whether there is more than one target object proximate to an avoid object; and in response to determining that there is more than one target object proximate to an avoid object, dividing a maximum, non-zero overall dose for the avoid object into an allocation for each target object, wherein the allocation is the maximum, non-zero dose used when defining the pattern for the target object.

The method may further comprise: determining whether there is more than one target object proximate to an avoid object; in response to determining that there is more than one target object proximate to an avoid object, determining whether a maximum, non-zero overall dose for the avoid object gives a higher dose per unit area than a local maximum, non-zero dose per unit area for the avoid object; and in response to determining that the maximum, non-zero overall dose for the avoid object does not give a higher dose per unit area than a local maximum, non-zero dose per unit area for the avoid object, dividing a maximum, non-zero overall dose for the avoid object into an allocation for each target object, wherein the allocation is the maximum, non-zero dose used when defining the pattern for the target object.

Defining the pattern of spot sprays may comprise: determining a spray size and stride such that when the spot sprays are staggered, no area will receive less than the minimum dose; generating a plurality of resultant patterns, each resultant pattern corresponding to a different one of a plurality of a plurality of candidate starting positions for an array of spot sprays; and selecting a resultant pattern from the plurality of resultant pattern that minimizes wastage of agrochemicals, wherein each resultant pattern is generated by: positioning an array of spot sprays at the determined size and stride over an entire spray window, starting at the candidate starting position; removing all spot sprays from the array that do not touch any target object; removing spot sprays until each proximate avoid object receives less than the maximum, non-zero dose; and removing any spot sprays that are not necessary to reach the minimum dose over the pre-defined proportion of any of the target objects; and combining the array portions for each of the target objects.

The pre-defined proportion of the target object may be less than all of the target object and the method may further comprise: identifying a portion of the target object that does not receive the minimum dose; and updating the pattern of spot sprays by adding one or more additional spot sprays over the portion of the target object.

The pre-defined proportion of the target object may be all of the target object.

The two-dimensional liquid spatial distribution for a spot spray may be determined based on a static two-dimensional liquid spatial distribution for a nozzle and received motion data for the spray assembly.

The two-dimensional liquid spatial distribution for a spot spray may be determined based on a static two-dimensional liquid spatial distribution for a nozzle and a detected distance between the nozzle and the target object.

The two-dimensional liquid spatial distribution for a spot spray may be determined based on a static two-dimensional liquid spatial distribution for a nozzle and an opening duration of the nozzle.

The two-dimensional liquid spatial distribution for a spot spray may be defined in a look-up table.

The two-dimensional liquid spatial distribution for a spot spray may be defined using a mathematically defined distribution.

The method may further comprise: adjusting an opening duration of a nozzle to maintain a constant two-dimensional liquid spatial distribution for a spot spray in response to changes in forward speed of the nozzle during spraying.

The method may further comprise: adjusting the pre-defined minimum dose based on a size or type of the target object.

A second aspect provides a computer program comprising instructions which, when the program is executed by a computer, cause the computer to carry out any of the methods described above (including any combination of the features described above).

A third aspect provides a computer-readable medium having stored thereon the computer program described above.

A fourth aspect provides a spot spray control system for spraying agrochemicals using a spray assembly, the spray assembly comprising an array of nozzles wherein an opening time and opening duration of the nozzles can be individually controlled and the spot spray control system comprising: a processor; one or more interfaces configured to receive target object data and output control signals to the spray assembly; and memory arranged to store a computer program which, when executed by the processor, causes the control system to: (i) identify a target object and a proximate avoid object; (ii) define by their placement and opening duration, a pattern of spot sprays such that a maximum, non-zero, dose applied to the proximate avoid object is not exceeded and at least a minimum dose per unit area is applied to a pre-defined proportion of the target object, wherein each spot spray is defined by a non-homogeneous two-dimensional liquid spatial distribution modified by a distance from the nozzle to the target object, the forward speed of the spray assembly and the opening duration of the nozzle; (iii) generate control signals for the array of nozzles according to the pattern of spot sprays; and (vi) output the control signals to the spray assembly.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The embodiments described below are not limited to implementations which solve any or all of the disadvantages of known methods of controlling spraying of agrochemicals.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a first example spot spraying system;

FIG. 2 is a schematic diagram of a second example spot spraying system;

FIG. 3 is a schematic diagram of a dual spray bar arrangement;

FIG. 4 shows two different examples of one dimensional (1D) spot spray dose profiles;

FIG. 5 shows an example shape of a spot spray;

FIG. 6 shows an example representation of a 2D liquid spatial distribution of a spot spray in the form of a look-up table, and the 1D liquid spatial distribution through the spot spray along central transversal and longitudinal axis;

FIG. 7 shows two examples of a resultant 2D liquid spatial distribution for a spot spray as a result of different opening durations and a forward movement;

FIG. 8 shows an example method of operation of spot spray control system, such as the spot spray control system 102 shown in FIG. 1.

FIG. 9 shows a first example method of generating a pattern of spot sprays for use in the method of FIG. 8;

FIGS. 10 and 11 are graphical representations showing the generation of a pattern of spot sprays using the method of FIG. 9;

FIG. 12A shows a second example method of generating a pattern of spot sprays for use in the method of FIG. 8;

FIG. 12B shows a variation on the method of FIG. 12A;

FIG. 13A shows a third example method of generating a pattern of spot sprays for use in the method of FIG. 8;

FIG. 13B shows a variation on the method of FIG. 13A;

FIGS. 14, 15, 16, 17A, 17B, and 18 are graphical representations showing the generation of a pattern of spot sprays using the method of FIG. 13A;

FIG. 19 shows a fourth example method of generating a pattern of spot sprays for use in the method of FIG. 8;

FIG. 20 shows a fifth example method of generating a pattern of spot sprays for use in the method of FIG. 8;

FIG. 21 shows an example method of adjusting a minimum dose;

FIG. 22 shows a method of modifying a pattern of spot sprays generated using the method of any of FIGS. 9, 12A, 12B, 13A, 13B, 19 and 20;

FIG. 23 illustrates various components of an example spot spray control system in the form of a computing-based device; and

FIG. 24 is a schematic diagram showing overlapping spray windows.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

As described above, spot spraying of agrochemicals can be significantly more efficient than continuous spraying. To be effective, however, spot spraying requires an efficient control system that can translate the target spray area into a set of control signals for the valves associated with the nozzles. Errors in this translation result in a mismatch between the target spray area and the actual spray area and this can reduce efficiency (e.g. where the actual spray area is larger than the target spray area) and effectiveness (e.g. by not spraying parts of the target spray area). In many applications, the target spray area is determined in real-time (e.g. using a camera system that scans an area of a field ahead of the spray bar passing over the area) and so the available time to perform the translation is very short (e.g. less than 500 ms).

An important spray parameter in the application of agrochemicals is the control of the dose per unit area. The highest level of spatial dose homogeneity must be guaranteed. Indeed, if the dose is not sufficient, the efficiency of the chemistry is reduced and may compromise the operation. If too high, the dose can exceed legal limits and be harmful for the environment, and/or cause harm to the crop plants through phytotoxicity. Applying too high a dose per unit area locally to a crop plant can also need to local burning of the crop plant. Use of too high a dose also leads to economical losses as a consequence of using more product than necessary.

Known control methods for spraying systems for agrochemicals rely upon each nozzle providing a homogeneous application within the spray pattern shape of the nozzle. In the case of a continuous spraying done with an array of nozzles mounted orthogonally to the displacement direction of the application machine, as there is no need to avoid some part of the ground, a good dose homogeneity is obtained by using nozzles with homogeneous lateral distribution profiles, having a relatively large jet divergence angle in the lateral direction (common values are 80 to 110 degrees), and separated laterally with a distance in general smaller than their vertical distance to the target, so that the jets of droplets produced by adjacent nozzles overlap largely together and combine into a dense lateral cloud of droplets distributed homogeneously when they hit the ground.

For the case of a spot spray application, a homogeneous application of droplets is much harder to obtain for the following reasons. First, as the area of a single spot spray must be as small as possible to be as spatially selective as possible (e.g. so that agrochemical is applied where it is needed and not on other neighbouring plants), the jet divergence angle of a nozzle must be much smaller than for a continuous spray (typically 15 to 25 degrees), which does not help in equalizing the dose over a large area. Second, the distance from nozzle to target must be as short as possible to guarantee the highest spot placement accuracy. Therefore, overlapping adjacent jets when both nozzle to target distance and jet divergence angle are small is a challenging task, as the resulting required nozzle to nozzle lateral distance becomes very small. Such a high density of nozzles leads to the need to use low flow nozzles to avoid applying too much product. Low flow nozzles are hard to fabricate and tend to get clogged easily. Third, as the movement of the application machine can be fast (e.g. several meters per second), the opening duration of the electromechanical valves associated with the nozzles must be very short to produce short spots in the forward direction. This sets challenges in the design of the valve. Fourth, the nozzle to target distance can vary during the application due to movement of the spray bar from ground, or ground irregular surface, or difference of heights between targets to be sprayed (e.g. where the plant height varies). Such a varying distance from nozzle to target renders the control of adjacent overlap ratio difficult. When the overlap ratio is not well controlled, it is difficult to base upon a specific nozzle lateral dose profile to get homogeneity through overlapping, as this overlapping can rapidly change from 2 jets overlapping to 3 jets overlapping, for instance, when the vertical distance increases.

All these elements render the application of a homogeneous dose difficult on spot spraying, both for single spot sprays (i.e. when a single nozzle is activated) or for larger spot sprays resulting in the cumulative action of several neighboring nozzles. Nevertheless, dose control remains a significant concern in spot spray devices. Therefore, there is a strong need to develop methods that enable control of the dose in spot spray equipment characterized by dense nozzle arrays with small jet divergence angles and small nozzle to target distances (typically 20 to 30 cm).

Described herein are improved methods of controlling spot spraying of agrochemicals. The methods described herein define a pattern of spot sprays based on the detected positions of one or more target objects and one or more avoid objects. A target object is a plant that requires spraying and the avoid object is a plant that does not require spraying. The pattern of spot sprays is defined such that a predefined, non-zero, maximum dose of the agrochemical for an avoid object is not exceeded (where this maximum dose may be a global or local dose) and with the aim of delivering a predefined minimum local dose to as much as possible, if not all of, a target object, even located in close vicinity to the avoid object. Having defined the pattern of spot sprays, control signals are generated for an array of nozzles in a spray assembly based on the pattern and output to the spray assembly.

While in many applications of agrochemicals, the control of the dose results in ensuring that a desired target object to be sprayed will receive a minimal amount of product per unit area, several applications require dose control to do exactly the opposite: ensuring that a given object not to be sprayed, hereafter called an avoid object, will not receive more than a given quantity of product per unit area. The present invention deals specifically with this second requirement (dose control over an object to be avoided), while being also fully compatible with the first one (dose control over an object to be sprayed).

The agrochemicals sprayed using the methods described herein may have any of the purposes found in plant protection or plant fertilization and so the plant that is a detected target object, or which may form part of a detected target object where the target object is a cluster of plants, may be a crop or a weed. Similarly, a plant that is a detected avoid object, or which may form part of a detected avoid object where the target object is a cluster of plants, may be a crop or a weed. The spraying of an avoid object is detrimental to the overall objective of the use of the agrochemicals, e.g. because it results in a crop plant being sprayed with herbicide or it results in a weed being sprayed with fertilizer.

Examples of agrochemicals that may be sprayed using the methods described herein include fertilizers, herbicides, fungicides, insecticides or another other agrochemical that promotes or inhibits growth or prevents diseases or plagues. Further examples of agrochemicals that may be sprayed using the methods described herein include other liquids such as hot water or hot oil for thermal weeding, or any other liquid used for weeding or crop care operations.

The methods described herein may be implemented in real-time as the spray assembly traverses the field and sprays the detected target objects. As described in more detail below, the methods may be implemented within each spray window where the size of the spray window is defined based on the width of the spray assembly, the characteristics of the imaging system used to scan the field, the distance separating the field portion observed by the imaging system from the spray system, and the forward speed of the spray assembly.

The methods described herein may take into account the non-homogeneity of the two-dimensional (2D) liquid spatial distribution of a nozzle. This 2D non-homogeneous liquid spatial distribution may be used when defining the pattern of spot sprays.

By using the methods described herein, the efficiency and adaptability of the spot spraying is increased. By precise control of the agrochemicals delivered to both target objects and avoid objects, the overall amount of agrochemicals sprayed can be reduced, thereby improving efficiency and effectiveness and reducing unwanted side effects, such as phytotoxicity for the crop plants, as well as the environmental impact of both the use of the agrochemicals and their fabrication and transport.

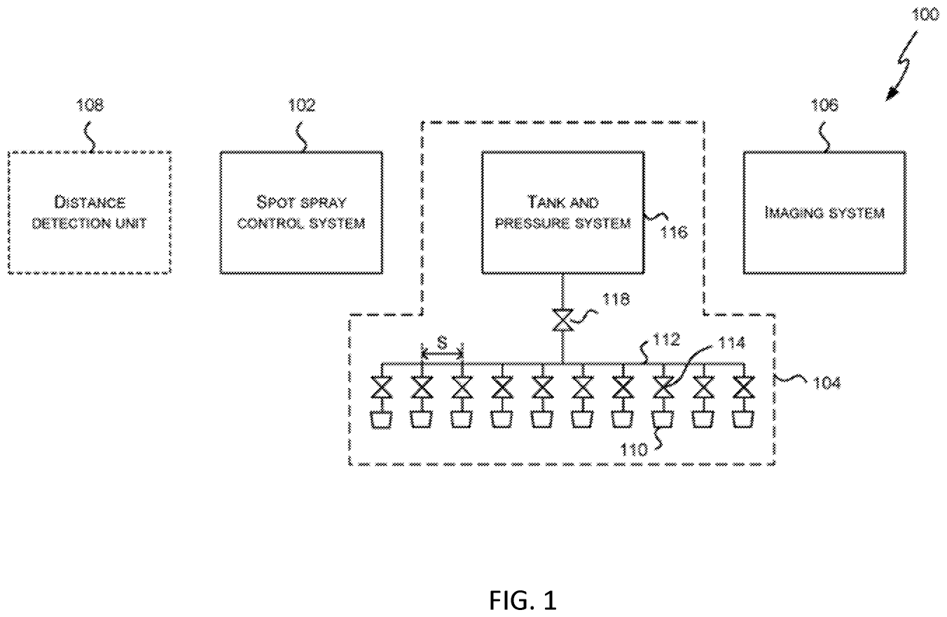

FIG. 1 shows a schematic diagram of a first example spot spraying system 100. The system 100 comprises a spot spray control system 102, a spray assembly 104 and an imaging system 106. The spot spraying system 100 may also comprise a distance detection unit 108. It will be appreciated that the spot spraying system 100 may comprise other elements not shown in FIG. 1, such as one or more sensors (e.g. an accelerometer, a GPS receiver, a sensor, etc.).

The spray assembly 104 comprises a plurality of nozzles 110 mounted on a spray bar 112. The nozzles 110 are mounted at a regular spacing, s, along the spray bar 112. Each nozzle 110 has an associated electromechanical valve 114 that is positioned between the nozzle 110 and the spray bar 112. These electromechanical valves 114 can be switched on and off rapidly and precisely to control the flow of fluid from each nozzle 110 and generate each spot spray. A spot spray refers to the fluid output from a nozzle 110 in a single valve opening (i.e. between the valve opening and subsequently closing again). The time that the valve 114 is open and generating a single spot spray may be referred to as a spot duration or opening duration, t, and may be in the region of 3-20 ms. The spray bar 112 is in fluid communication with a tank and pressure system 116 via an optional inlet electromechanical valve 118. The tank and pressure system 116 comprises a tank for holding the agrochemical that is to be sprayed and a pressure system that generates and controls the pressure, p, at which the agrochemical is supplied from the tank to the spray bar 112 and ultimately to the nozzles 110. The volume of fluid output in a single spot spray is a function of the opening duration, the nozzle design (e.g. nozzle diameter) and the pressure and the area that the single spot spray covers (and hence the dose per unit area) is also dependent upon the distance between the nozzle and the surface (e.g. the ground). The inlet valve 118 enables the tank and pressure system 116 to be isolated from the spray bar 112, e.g. for maintenance purposes.

It will be appreciated that the spray assembly 104 may differ from that shown in FIG. 1. For example, the valves 114 may be integrated into the spray bar 112, there may be more than one spray bar 112 and/or the inlet valve 118 may be omitted.

The imaging system 106 scans a portion of a field ahead of the spray bar 112 passing over the area and identifies both target objects (for spraying) and avoid objects (which should not be sprayed). This portion of the field that is scanned at any one time may be referred to as the spray window and its size is dependent on the width of the imaging system and spray system, on the distance separating the portion of the field observed by the imaging system and the spray system, and the forward speed of the spray assembly 104. The scanning may be performed continuously or periodically (e.g. every 100 ms). Where the scanning is performed periodically, the resulting spray windows may overlap (in the direction of the forward motion of the spray assembly) or be contiguous depending upon the time between scanning operations. The scanning operation is performed sufficiently frequently to avoid gaps between the spray windows. As described above, depending upon the type of agrochemical being sprayed, the target object may be a desired plant (i.e. a crop) or an undesired plant (i.e. a weed). Similarly, the avoid object may be a desired plant (i.e. a crop) or an undesired plant (i.e. a weed). The imaging system 106 may comprise one or more cameras and/or other sensors and a processing system arranged to process the data captured by the cameras and/or other sensors and output data defining both a target object to be sprayed and an avoid object which should not be sprayed.

Where included, the distance detection unit 108 determines, for one or more points (e.g. each point of the ground), a distance between the spray bar 112 and the target object (i.e. the highest part of the plant to be sprayed). For many applications, the agrochemical is sprayed, by the nozzles 110, substantially vertically downwards and the distance determined by the distance detection unit 108 is a vertical height. In other spraying orientations (e.g. spraying a substantially vertical surface), the distance detection unit 108 still determines a distance between the spray bar 112 and the target object but this may, for example, be in a vertical plane. Any suitable technology may be used to perform distance detection (e.g. height detection) and in an example, the distance detection unit 108 may comprise 3D depth sensors or distance range sensors. The distance detection unit 108 may determine a single distance for the entire spray bar (e.g. the minimum distance between the spray bar and the target objects that are underneath the spray bar) or more granular distance data may be determined, e.g. per group of adjacent nozzles, per nozzle or even finer.

The spot spray control system 102 generates control signals for the valves 114 associated with the nozzles 110 in the spray assembly 104 based on input received from the imaging system 106 and optionally based on input received from the distance detection unit 108. The spot spray control system 102 performs the improved methods of controlling spot spraying of agrochemicals described herein and these are described in more detail below.

Whilst the distance detection unit 108, imaging system 106 and spot spray control system 102 are shown as separate elements in FIG. 1, it will be appreciated that some or all of them may share common components (e.g. the distance detection unit 108 and imaging system 106 may share sensors and any or all of them may share processing capabilities) or two or more of the distance detection unit 108, imaging system 106 and spot spray control system 102 may be combined.

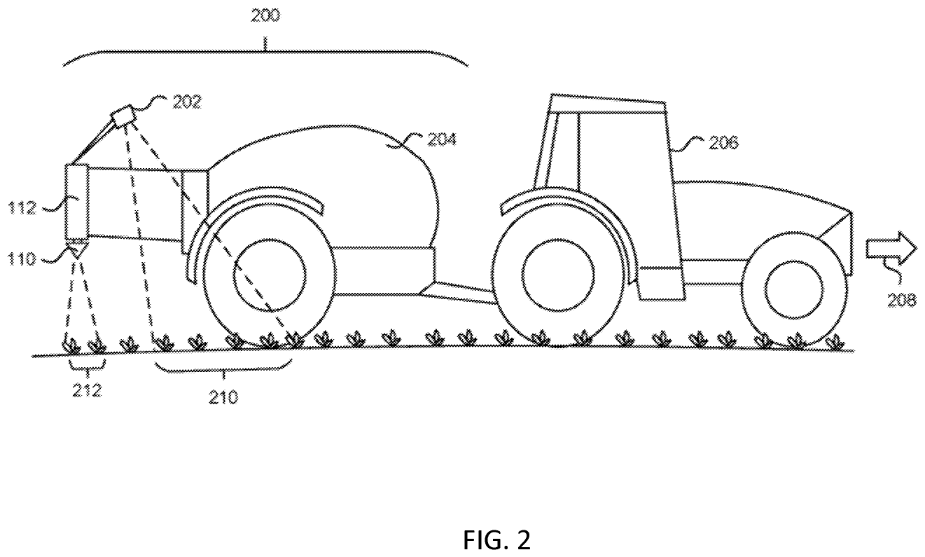

FIG. 2 shows a schematic diagram of a second example spot spraying system 200. The system 200, like that shown in FIG. 1, comprises a spot spray control system, a spray assembly, an imaging system and optionally a distance detection unit, although only some elements of these are visible in FIG. 2. In particular, FIG. 2 shows the nozzles 110 and spray bar 112 as well as a camera 202 that is part of the imaging system. The tank and pressure system, the spot spray control system and other parts of the imaging system may be located within the body 204 of the spot spraying system 200. In this example, the spot spraying system 200 is towed behind a vehicle 206 (e.g. a tractor) and the direction of travel of the vehicle, when moving forwards, is marked by an arrow 208. As shown in FIG. 2, the imaging system scans a portion of a field 210 ahead of (i.e. before) the spray bar 112 passing over the area, i.e. the area being sprayed 212 is behind the area being scanned 210. As the distance between the scanned portion of the field 210 and the area being sprayed 212 is fixed, the time delay between the scanning of the field and the spray bar passing over the area can be calculated if the forward speed of the vehicle 206 is known. This is taken into consideration when generating control signals for the electromechanical valves 114 in order to spatially synchronize the spot sprays and the target and avoid objects. The scanned portion of the field 210 is the spray window and whilst not visible in FIG. 2, the spray window has a width that corresponds to the width of the spray bar 112, this width requires generally several cameras 202 to be observed in its totality (although only one camera 202 is visible in FIG. 2).

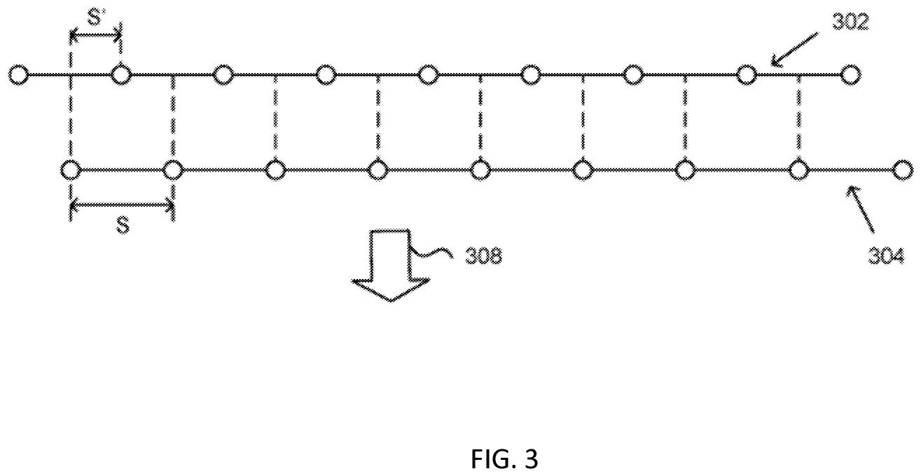

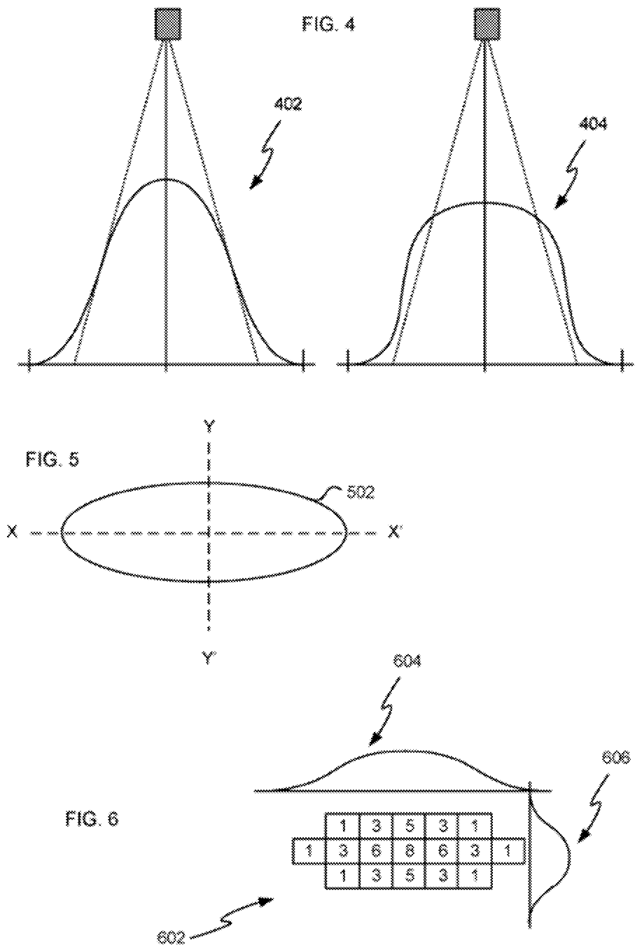

The spray assemblies shown in the systems 100, 200 in FIGS. 1 and 2 each comprise a single spray bar 112 with nozzles 110 mounted at a regular spacing, s, along the spray bar 112. In some example systems, the spray assemblies may comprise a plurality of spray bars with the nozzles on different spray bars offset from each other. In the example shown in FIG. 3, each of the spray bars 302, 304 has nozzles mounted at a regular spacing, s, but the nozzles are offset between the spray bars giving an effective nozzle spacing of the overall spray assembly of s'=s/2. The effective nozzle spacing may be further reduced by having more than two spray bars, e.g. s/3 for three spray bars, s/4 for four spray bars, etc. The spray bars are oriented perpendicular to the direction of travel of the system so that where there are a plurality of spray bars in a spray assembly, these are spaced from each other in the direction of travel which is indicated by arrow 308 in FIG. 3. The control methods described herein may be used with any arrangement of spray bars and nozzles. Of course, when valve control signals are directed to several bars in parallel, the control signals of the second or following bars must be delayed accordingly with the forward speed of the bars so that the spray spots of all bars are disposed on a same lateral line on the ground.

Where the static 2D liquid spatial distribution of a nozzle is not assumed to be uniform it may be mathematically defined, e.g. in terms of parameters that define one or more equations, such as a Gaussian or normal distribution, that correspond to the distribution in 2D. Any form mathematical equation may be used to define the static 2D liquid spatial distribution of a nozzle. FIG. 4 shows two different examples of one dimensional (1D) spot dose profiles 402, 404. These 1D profiles 402, 404 may represent the dose profile taken along a line through an elliptical spot spray 502 as shown in FIG. 5, e.g. along the line X-X′ or the line Y-Y'. In other examples, the static 2D liquid spatial distribution of a nozzle that is input to the method may be input in the form of a pre-calculated look-up table. For example, the look-up table may sub-divide the 2D spatial distribution into a 2D grid of cells and specify the dose received within each cell, as shown in the example 602 in FIG. 6. As well as showing an example look-up table 602, FIG. 6 also shows the equivalent 1D distributions 604, 606 along two perpendicular lines passing through the centre of the spot spray (e.g. along the equivalent of lines X-X′ and Y-Y′ shown in FIG. 5).

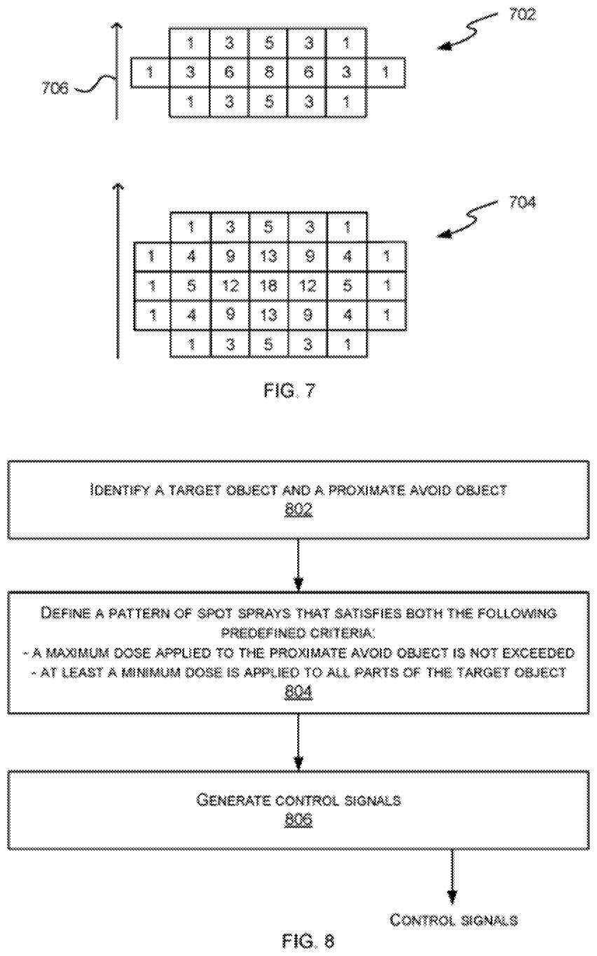

The non-homogeneous 2D liquid spatial distribution shown in FIGS. 4-6 assumes that the nozzle is static and is dependent upon the nozzle design; however, as the spray assembly is moving, the resultant 2D liquid spatial distribution for any spot spray is a modified version of the static 2D liquid spatial distribution as a result of the motion during the period of time that the valve associated with the nozzle is open. As noted above, the opening duration for a valve may be in the range of 3-20 ms and the forward speed of the spray assembly may be around 2 m/s, resulting in the nozzle moving by around 1-4 cm during the time that the valve is open. FIG. 7 shows two examples of a resultant 2D liquid spatial distribution 702, 704 for a spot spray as a result of different opening durations for a given forward speed of the nozzle. In the first example resultant 2D liquid spatial distribution 702, the opening duration is 5 ms and in the second example resultant 2D liquid spatial distribution 704, the opening duration is 15 ms. The arrow 706 shows the direction of motion of the spray assembly and both the increased dose and increased spreading as a consequence of the increased opening duration are clearly visible in the second example.

When the spray assembly is moving in a direction perpendicular to the spray bar (e.g. forwards) the speed of each nozzle is the same; however, if the motion of the spray assembly includes some rotation (e.g. because a corner is being turned), the speed of the nozzles will differ across a spray bar. Consequently, even if the same static 2D liquid spatial distribution is used for each nozzle, the resultant 2D liquid spatial distribution may differ between nozzles.

In some examples, the same static 2D liquid spatial distribution may be used irrespective of the distance between the spray bar 112 and the target object, as determined by the distance detection unit 108. In other examples, the static 2D liquid spatial distribution that is used is dependent upon the detected distance. For example, the same static 2D liquid spatial distribution may be modified dependent upon the height when calculating the combined dose (e.g. in an analogous manner to the modification that is performed based on the forward motion of the spray assembly). In other examples, different static 2D liquid spatial distributions may be stored and used for different distances between the spray nozzles and the target object. An increased distance results in a larger (i.e. upscaled) spot spray but in a lower dose per unit area, as the sprayed volume is unchanged but is spread over a wider area. In some examples there may be a single detected distance provided by the distance detection unit 108 that is used for all nozzles (e.g. a single distance between the spray bar and the target object); however in other examples, more granular distance data may be provided, such as distance data per nozzle. Consequently, even if the same static 2D liquid spatial distribution is used for each nozzle and even if all nozzles are travelling at the same speed, the resultant 2D liquid spatial distributions may differ between nozzles (e.g. where the underlying surface is not flat and/or where the height of the target object differs).

As the spreading of the static 2D liquid spatial distribution is dependent upon the translational speed (e.g. forward speed) of the spray assembly, in some examples, the opening duration of the nozzles may be adjusted to compensate for changes in speed (e.g. as determined from the motion data that is input to the method). However, as changing the opening duration modifies the dose, even where this is used, the individual spray spots may have different maximum applied doses. This means that the combined dose of the spot sprays and their arrangement, will vary depending upon the local nozzle speed.

FIG. 8 shows an example method of operation of spot spray control system, such as the spot spray control system 102 shown in FIG. 1. As shown in FIG. 7, the method comprises identifying both a target object and an avoid object that is proximate to the target object (block 802). This identification (in block 802) may be performed by the imaging system 106.

The proximate avoid object that is identified may be within a predefined range of the target object, e.g. touching the target object or within a few centimeters of the target object. Using position data for the detected target object and avoid object, the method then defines a pattern of spot sprays that satisfies both the following predefined criteria: (i) a maximum, non-zero, dose applied to the proximate avoid object is not exceeded and (ii) at least a minimum dose is applied to ideally all parts of the target object (block 804). Control signals are then generated for the defined pattern (block 806) and these are then output to the spray control system. The control signals may include a control signal for each nozzle in the spray assembly and define when the nozzle opens and when the nozzle closes (which in turn defines the opening time, i.e. the time at which the nozzle opens, and the opening duration, i.e. the length of time that the nozzle is open for). These time values in turn specify the position of the spot spray (based on the forward speed of the spray assembly) and the size of the spot spray (as this is dependent upon the opening duration which is the interval between the opening and closing of the nozzle). These control signals cause the spray control system to deliver the defined pattern of spot sprays.

The minimum dose that is defined in relation to the target object and used in criteria (ii) above is a local dose, i.e. a minimum dose that is to be applied to all parts of the target object. This minimum dose may be defined in terms of an amount of the agrochemical per unit area (e.g. in g/cm² or ml/cm²).

The maximum dose that is defined in relation to the proximate avoid object and used in criteria (i) above may be a local dose (i.e. a maximum dose that should be applied to any part of the target object) or a global dose (i.e. a maximum dose that should be applied to the target object as a whole). For a local maximum dose, it may be defined in terms of an amount of the agrochemical per unit area (e.g. in g/cm² or ml/cm²). For a global maximum dose, it may be defined in terms of an absolute amount of the agrochemical for the target plant (e.g. in g or cm3). This absolute amount may be derived from an amount of the agrochemical per unit area (e.g. in g/cm² or ml/cm²) by multiplying by the total area of the plant. The total area of the plant may be determined by the imaging system 106 (e.g. using image analysis).

As described above, the maximum dose is non-zero (i.e. it is more than zero) which means that some of the agrochemical will be sprayed onto the avoid object and the maximum dose may be defined to avoid negative effects such as death/damage of the avoid object or undesirable (or unsafe) levels of residues within the plant (e.g. where the avoid object is a crop plant) or improved growth (e.g. where the avoid object is a weed).

It will be appreciated that there may be more than one target and/or avoid object that is identified (in block 802). Where there is more than one target object, then a single pattern may be defined which satisfies the minimum dose criteria (ii) for all target objects. Alternatively separate patterns may be defined, one for each target object. Where there is more than one avoid object, the pattern or patterns that are defined collectively satisfy the maximum dose criteria (i) for each avoid object. It is also to be observed that the method also applies when different types of target objects or avoid objects are present, each requiring different levels of minimum dose (for the target objects) or maximum dose (for the avoid object), the imaging and real-time object classification system being able to determine the type of object and therefore identify a corresponding minimum or maximum dose for this object. For instance, if several species of weeds are present in a crop field and need to be sprayed, the minimal dose to be applied may be defined per specie.

Another case is when several species of avoid plants are present in a same field, a maximum dose may be defined for each specie, for instance to take into account their sensitivity to the chemicals in use. If a species is less prone to damage than another one, it is preferable to adjust the level tolerated so as to facilitate the application of a minimum amount to target plants in a direct vicinity.

The same modification of minimum and maximum dose can be applied in function of the size of the objects to be sprayed. For instance, a small crop plant may be much less resistant to an herbicide than a well developed plant, and therefore the maximum dose permitted on this small plant will be defined to be lower than the maximal dose allowed on a larger avoid plant.

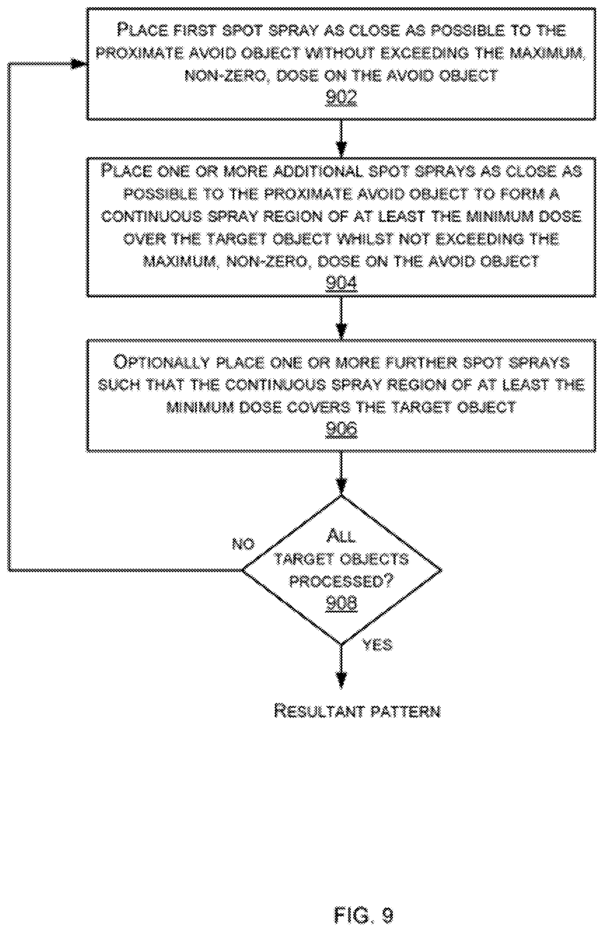

To define the pattern (in block 802), the positions of one or more spot sprays are determined using the position of the target and avoid objects and then the 2D liquid spatial distribution of a spot spray is used to calculate the doses applied to each object (e.g. by summing the contributions from spot sprays at different positions). These calculated doses are then compared to the two criteria and then the positions of one or more of the spot sprays may be adjusted and/or the number of spot sprays is changed (by adding or removing one or more spot sprays). As described above the 2D liquid spatial distribution of a spot spray may be non-homogeneous, may depend on the forward speed and on the valve opening duration (i.e. the time between when the valve is opened and then subsequently closed) and may be defined mathematically or stored in a look-up table. Various different methods of defining the pattern (in block 804) are shown in FIGS. 9, 12A, 12B, 13A, 13B and 19 and described below.

FIG. 9 shows a first example method of defining a pattern of spot sprays that satisfies the criteria detailed above (in block 804). In this first example method, a first spot spray is placed as close as possible to the proximate avoid object without exceeding the maximum, non-zero, dose on the avoid object (block 902). One or more additional spot sprays are then placed as close as possible to the proximate avoid object to form a continuous spray region of at least the minimum dose over a portion of the target object whilst not exceeding the maximum, non-zero dose on the avoid object from the combination of the first spot spray and these newly placed additional spot sprays (block 904). Finally, one or more further spot sprays are placed, if and where necessary, further from the proximate avoid object to extend the continuous spray region so that it fully covers the target object (block 906).

Within the continuous spray region, the dose at any point is not less than the predefined minimum dose. Where there is more than one target object that has been identified (in block 802), the method may then be repeated until all target objects have been processed (‘Yes’ in block 908). The term ‘processed’ is used in the context of FIG. 9 to refer to placing spot sprays over the target object (i.e. performing blocks 902-906 in relation to that target object). The continuous spray region for one target object may or may not overlap with the continuous spray region for another target object which means that the from all placed spots (in blocks 902-906 for all target objects) provides one or more spray regions.

The positions of the spot sprays that are placed in the method of FIG. 9 are constrained in the axis perpendicular to the direction of travel of the system (and hence parallel to the spray bar) by the nozzle spacing, or effective nozzle spacing where the spray system comprises a plurality of spray bars (e.g. as shown in FIG. 3). This axis which is perpendicular to the direction of travel of the system may be referred to as the transverse axis and the position of the spot sprays along this axis may be referred to as transverse offsets (e.g. from an origin at one end of the spray bar). The longitudinal offsets are along a direction parallel to the direction of travel of the system (and perpendicular to the spray bar) and each longitudinal offset corresponds to a duration of motion of the spray assembly at a known speed. This speed which corresponds to a speed over the surface on which the target object is located may be referred to as the displacement speed or forward speed to distinguish it from the speed at which a nozzle is turned on and off by controlling the corresponding electromechanical valve. The transverse offset defines which nozzle on a spray bar is used (and hence which electromechanical valve is switched on and off), whereas a longitudinal offset defines the temporal spacing of the spot sprays and hence the control signals.

In addition to defining the position of each spot spray, the opening duration of the nozzle is also defined. As described above, the 2D liquid spatial distribution of a spot spray is dependent upon on its opening duration. In some examples, the same opening duration may be used for all spot sprays, and in other examples, the opening duration may differ between spot sprays.

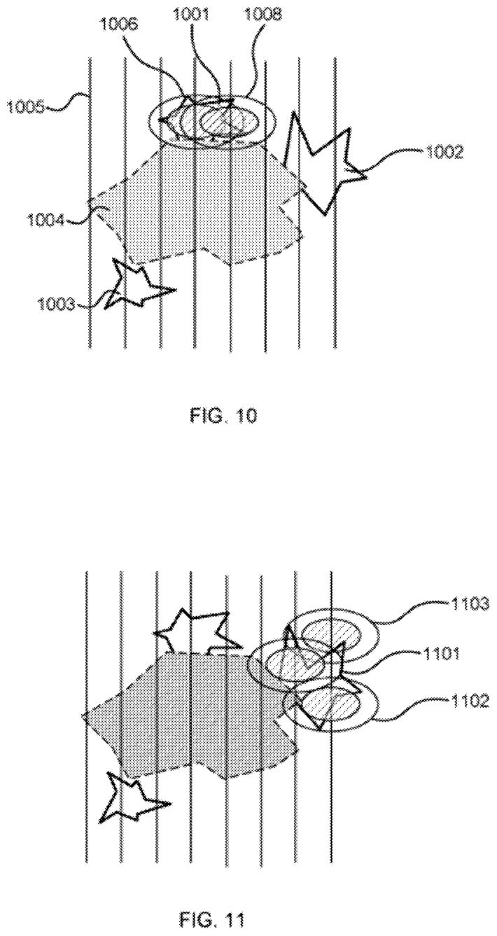

The method of FIG. 9 can be further described with reference to FIGS. 10 and 11. FIG. 10 shows the objects identified within a spray window and in the example shown this comprises three identified target objects 1001-1003 and an identified avoid object 1004. FIG. 9 also shows straight lines 1005 which indicate the path of the nozzles and hence any spot spray must be centered laterally on one of these lines. In the example shown there are eight straight lines 1005, each corresponding to one of the nozzles on the spray bar. It will be appreciated that there may be different numbers of nozzles on the spray bar and in some examples there may be more than eight nozzles on the spray bar.

A first spot spray 1006 is placed which overlaps the first target object 1001 and is as close as possible to the avoid object 1004 without exceeding the predefined maximum, non-zero, dose for an avoid object (in block 902). In FIG. 10 the spot spray is shown as two concentric ellipses, with the outer ellipse showing the maximum extent of the spray and the inner ellipse indicating the region in which the spray dose exceeds the predefined minimum dose for a target object. As the minimum dose for a target object will always be higher than the maximum, non-zero, dose for an avoid object, the first spot spray 1006 is placed such that the outer ellipse overlaps the avoid object but the inner ellipse does not. For this first target object 1001, one additional spot spray 1008 is then placed (in block 904) to extend the area of the target object 1001 that receives at least the minimum dose whilst not exceeding the maximum, non-zero, dose on the avoid object.

In the example shown in FIG. 10, the placement of the initial two spot sprays 1006, 1008 provides a continuous spray region of at least the minimum dose that covers the first target object 1001. The method is then repeated (‘No’ in block 908) for the next target object 1002, as shown in FIG. 11. To cover this second target object 1002, a first spot spray 1101 is placed close to the avoid object (in block 902) followed by a second spot spray 1102 that is also close to the avoid object (in block 904) and a third spot spray 1103 is then placed further from the avoid object to extend the continuous spray region over the target object 1002 (in block 906).

In the example method shown in FIG. 9 and described above, the maximum, non-zero dose that is defined for the avoid object may be a local dose, i.e. a dose per unit area.

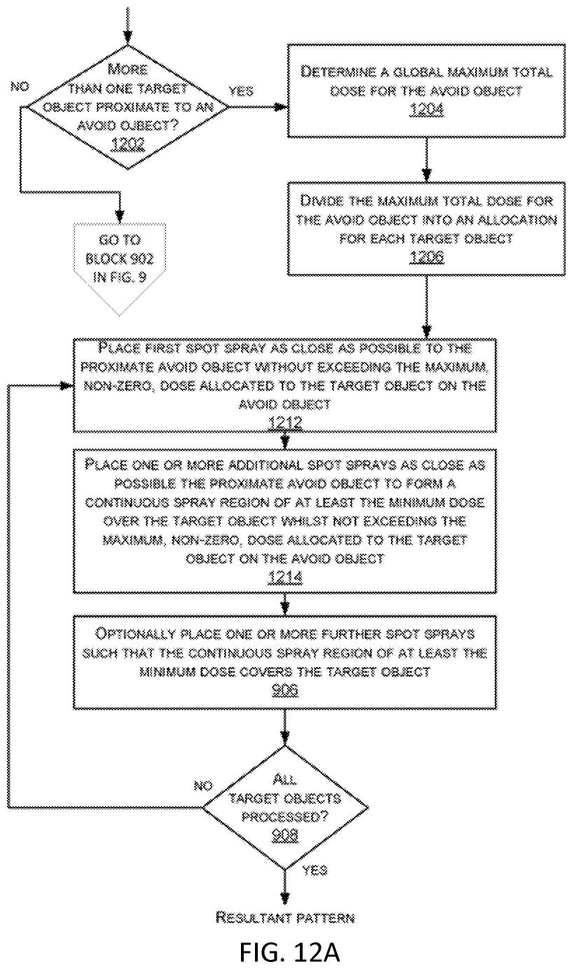

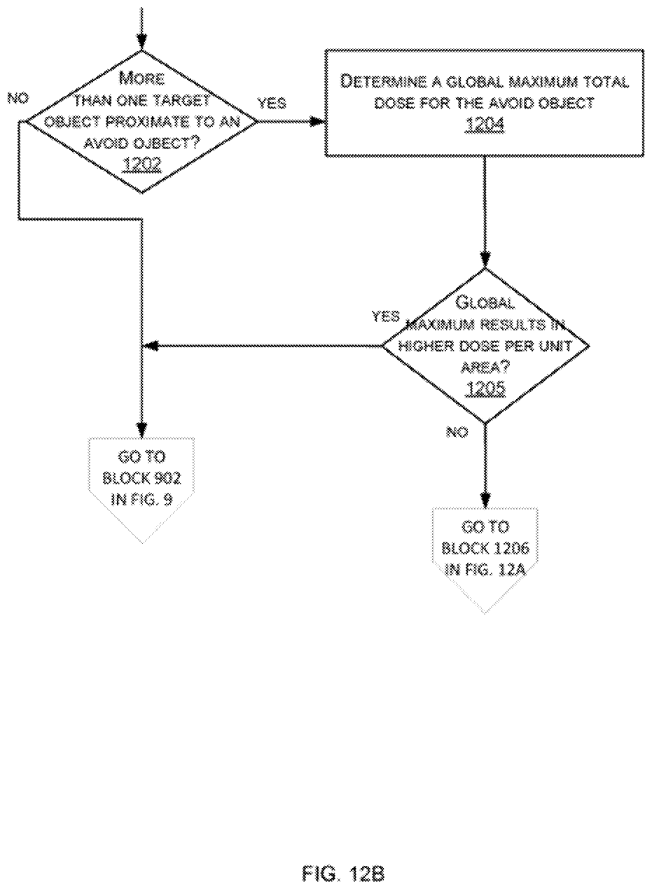

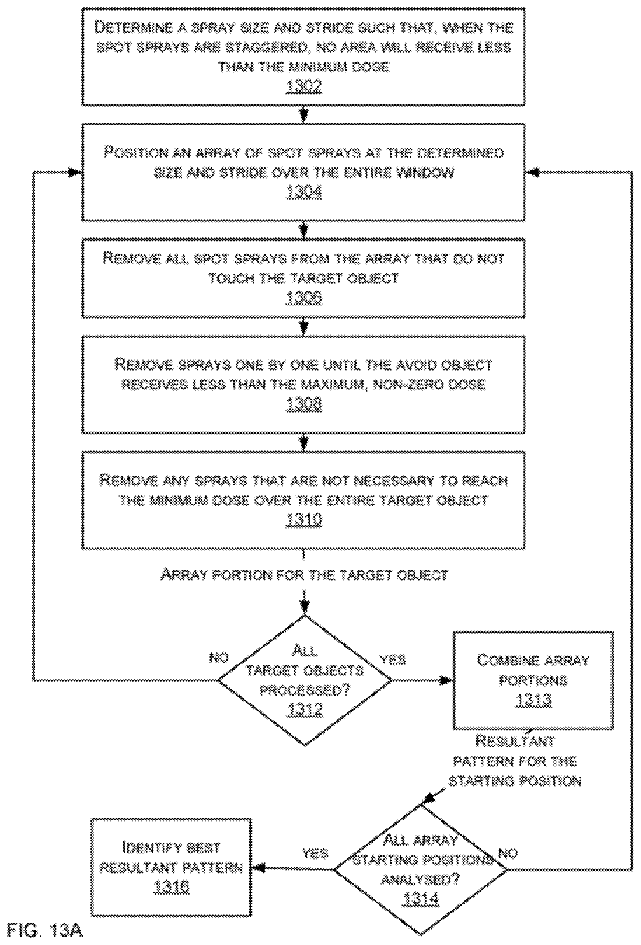

FIG. 12A shows a second example method of defining a pattern of spot sprays that satisfies the criteria detailed above (in block 804). This second example method is a variation on that shown in FIG. 9 and described above and is particularly useful where there may be more than one target object proximate to the same avoid object (as in the example shown in FIGS. 10 and 11) and where the maximum, non-zero, dose is a global maximum dose. Where there is only a single target object proximate to any avoid object (‘No’ in block 1202), the method of FIG. 12A operates in the same way as the method of FIG. 9.

As shown in FIG. 12A, if it is determined that there is more than one target object proximate to any single identified avoid object (‘Yes’ in block 1202), a global maximum total dose for the avoid object is determined (in block 1204). This may, for example, be determined by performing a look-up (e.g. in a table for the particular agrochemical being used). The global maximum total dose may be dependent upon the plant type of the avoid object or other criteria. As described above, the plant type may be determined by the imaging system 106 (e.g. using image analysis) and provided as an input to the method of FIG. 12A. Having determined the global maximum for the avoid object, this is divided up into an allocation for each target object that is proximate to the avoid object (block 1206). This may be implemented by dividing the global maximum by the number of proximate target objects, such that the allocation for each target object is the same.

Alternatively, different doses may be allocated to different proximate target objects, e.g. where the global maximum may be shared between proximate target objects according one or more criteria such as: the distance between the target object and the avoid object (where a larger dose is allocated to a first target object that is closer to the proximate object than to a second target object), the size of the target object (where a larger dose is allocated to a first target object that has a larger area than a second target object), etc.

Having performed the allocation (in block 1206), the method continues as described above with reference to FIG. 9 except that when processing a target object and placing the spot sprays close to the proximate avoid object, the allocated portion of the global maximum total dose is used to determine how close the spot spray can be placed (in block 1212 and 1214).

FIG. 12B shows a variation on the example method shown in FIG. 12A and described above. In the method of FIG. 12B both a local maximum and a global maximum dose are considered and then the most severe of the two (i.e. the one which corresponds to the smaller amount of agrochemical) is used. As shown in FIG. 12B, if the global maximum dose results in a higher dose per unit area than a local maximum dose (‘Yes’ in block 1205) then the method proceeds as shown in FIG. 9 and described above (i.e. using the maximum local dose). If, however, the global maximum dose results in a lower local dose than a local maximum dose (‘No’ in block 1205) then the method proceeds as shown in FIG. 12A and described above (i.e. by creating and using the allocations for each target object).

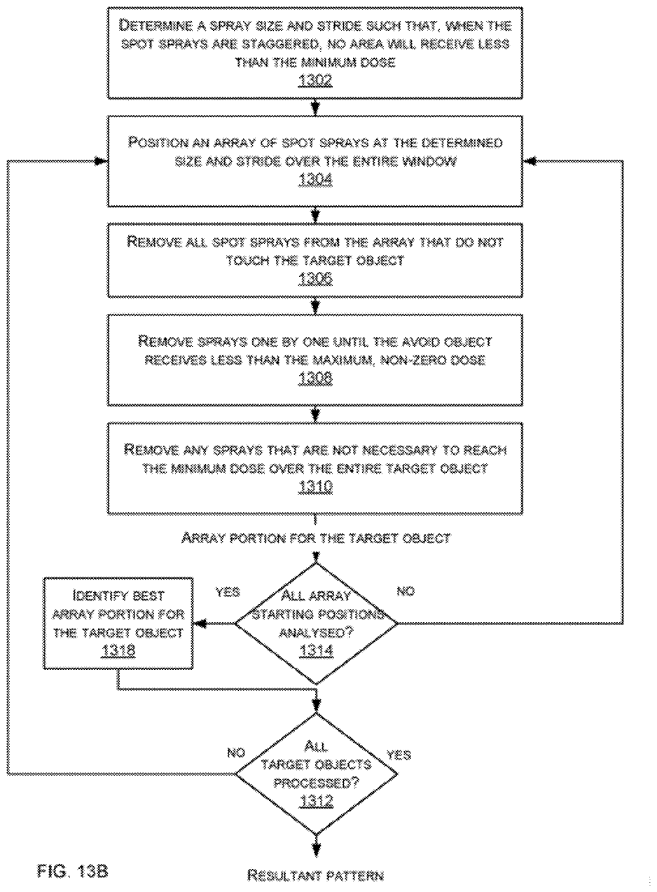

FIG. 13A shows a third example method of defining a pattern of spot sprays that satisfies the criteria detailed above (in block 804). In this third example, instead of adding spot sprays to create a continuous spray region that covers a target object, an array of spot sprays is defined that provides a continuous spray region over all (or substantially all) of the spray window and then spot sprays are removed from the array in order to satisfy the two criteria (i) and (ii) described above.

As shown in FIG. 13A, the method comprises determining a spray size and stride such that, when the spot sprays are staggered, no area receives less than the minimum dose (block 1302). The stride, which may also be referred to as the pitch, defines the offsets of spot sprays in both a transverse direction and a longitudinal direction. As described above, the offset in the transverse direction is constrained to be a multiple of the nozzle spacing. The spot size and/or offsets may be predefined and stored in a lookup table so that the determination (in block 1302) involves performing a lookup. The lookup table may define combinations of spray sizes and offsets for different spray bar heights (e.g. different distances between the nozzles and the target objects) and so the lookup may involve identifying the appropriate values from the lookup table that correspond to the current spray bar height. There may be different lookup tables for different spray bar types, nozzle arrangements (e.g. in terms of nozzle spacing and/or nozzle type) and/or agrochemicals. In some examples the spray size may be fixed and only the stride determined (in block 1302). The spray size may correspond to a particular opening duration for the nozzle.

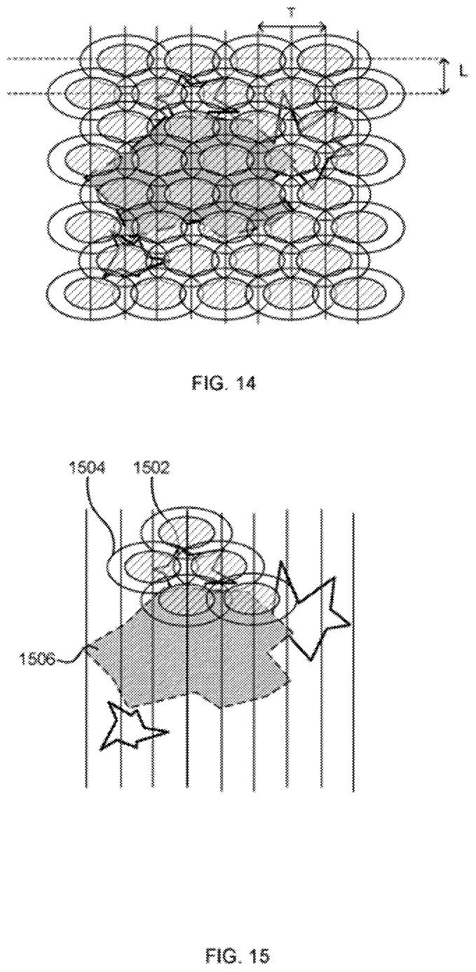

The method of FIG. 13A considers each identified target object within the spray window in turn. Having determined the spray size and stride (in block 1302), an array of spot sprays is positioned at the determined size and stride over the entire spray window (block 1304) and an example of this is shown in FIG. 14. FIG. 14 shows the transverse stride, T, which in this example is twice the nozzle spacing (or twice the effective nozzle spacing) and the longitudinal stride, L. It will be appreciated that the spray window (and hence the array) may be much larger than that shown in FIG. 14. For example, the array that covers the spray window may comprise tens of rows of spot sprays (e.g. 10-20 rows or even 50 rows, dependent upon the forward speed of the spray assembly).

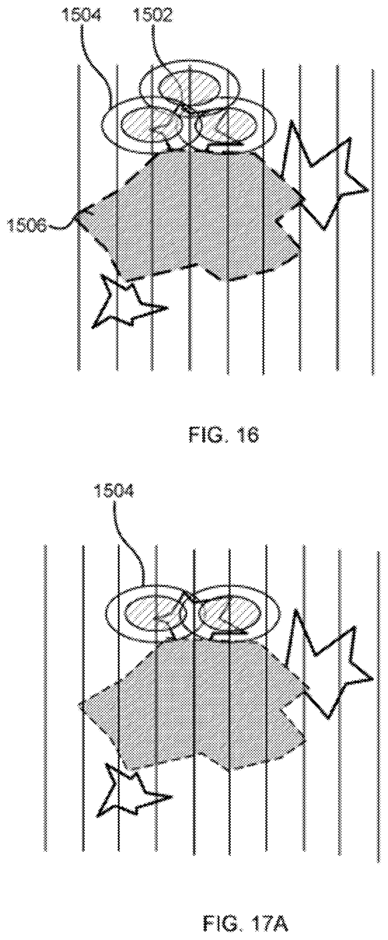

One or more spot sprays are then removed from this array based on various criteria (blocks 1306-1310). Firstly, all spot sprays in the array that do not touch the target object 1502 (or the first target object where there are multiple target objects identified within the spray window) are removed from the array (block 1306). FIG. 15 shows the effect of this removal step on the array shown in FIG. 14 and it can be seen that in this example, only five spot sprays 1504 remain. Then, spot sprays are removed one by one until the proximate avoid object 1506 receives less than the maximum, non-zero dose (block 1308). FIG. 16 shows the effect of this removal step on the remaining part of the array shown in FIG. 15 and it can be seen that in this example, only three spot sprays 1504 remain. Where there are multiple proximate avoid objects, all of these are considered when removing spot sprays (in block 1308). Finally, any spot sprays that are not necessary to reach the minimum dose over the entire target object are removed (block 1310). FIG. 17A shows the effect of this removal step on the remaining part of the array shown in FIG. 16 and it can be seen that in this example, only two spot sprays 1504 remain. The output of the three removal operations (blocks 1306-1310) for a target object is an array portion for the target object.

The method of FIG. 13A considers each identified target object within the spray window in turn, so having performed all the removal operations for the first target object (in blocks 1306-1310) and generated an array portion for the first target object, the method is repeated for each other identified target object (‘No’ in block 1312 followed by blocks 1304-1310) until all target objects have been processed (‘Yes’ in block 1312) and an array portion has been generated for each of the target objects identified within the spray window. As described above, to generate the array portions for the different target objects, each object starts with an identical array (in block 1304) but different spot sprays may be removed (in blocks 1306-1310) and so the array portions for different target objects will be different. Once array portions have been generated for all of the target objects (‘Yes’ in block 1312), these array portions are combined into a single pattern to produce a resultant pattern for all of the target objects (block 1313). When combining the array portions, the patterns are summed together to produce the resultant pattern of spot sprays and any duplicate spot sprays are removed (i.e. such that there is only one spot spray at any particular location in a resultant pattern). FIG. 17B shows the resultant pattern for all of the target objects and it can be seen that the resultant pattern comprises the two spot sprays for the first target object 1502, four spot sprays for the second target object 1704 and four spot sprays for the third target object 1706.

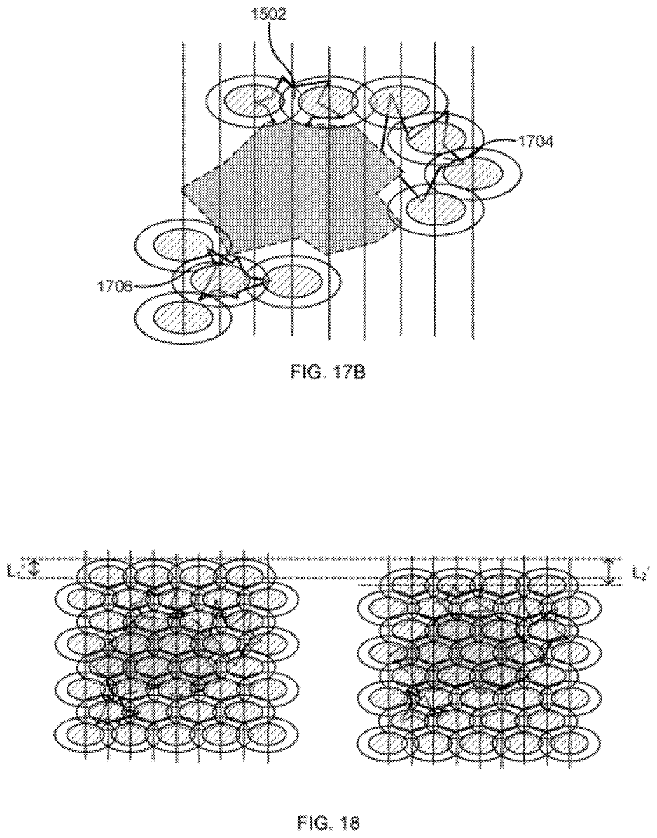

At this point in the method, it is determined whether all array starting positions are analysed (block 1314). These starting positions may be defined in terms of the longitudinal offset, L′, of the first row in the array of spots from the start of the spray window, as shown in FIG. 18. FIG. 18 shows two different starting positions, L1′ and L2′, and there may be one, two or more candidate starting positions (i.e. values of L′) which are analysed using the method of FIG. 13A before the best solution is identified and selected. If there are more candidate (i.e. possible) starting positions to analyse (‘No’ in block 1314) then the method of FIG. 13A (blocks 1304-1313) is repeated but with a slightly different initial placement of the array of spot sprays, as specified by the particular value of L′ being analysed (in block 1304). The only difference in the iterations of the method for the different starting positions is the placement of the initial array (in block 1304). The same criteria are then used to remove one or more spot sprays and because of the slightly different placement of the initial array (in block 1304), a different combination of spot sprays may be removed, resulting in a different resultant pattern of spot sprays for each starting position once all target objects have been processed (as output from block 1313).

Having determined the resultant patterns for each of the possible starting positions (‘Yes’ in block 1314), the best resultant pattern is identified (block 1316) and this is the pattern for which control signals are generated (in block 806 of FIG. 8). The best resultant pattern is the resultant pattern which results in the most efficient use of agrochemicals (i.e. when compared to the other resultant patterns for different starting positions).

Various different criteria may be used to assess the efficient use of agrochemicals, such as one or more of: amount of agrochemical sprayed on avoid objects and/or the amount of agrochemical sprayed overall. In either case, a smaller amount of agrochemical is better because it corresponds to the degree of wastage and/or excessive use (given that the minimum dose applied to target objects has already been guaranteed as a consequence of the earlier method steps).

Whilst FIG. 13A forms a resultant pattern for all target objects (in block 1313), in other examples, the array portion and starting position for each target object may be considered independently as shown in FIG. 13B. In this variation, the starting position is considered on a per-target-object basis and the best array portion is identified for each target object (block 1318).

It will be appreciated that whilst FIGS. 13A and 13B show block 1308 occurring before block 1310, in a variation on that shown the order of these two steps may be reversed.

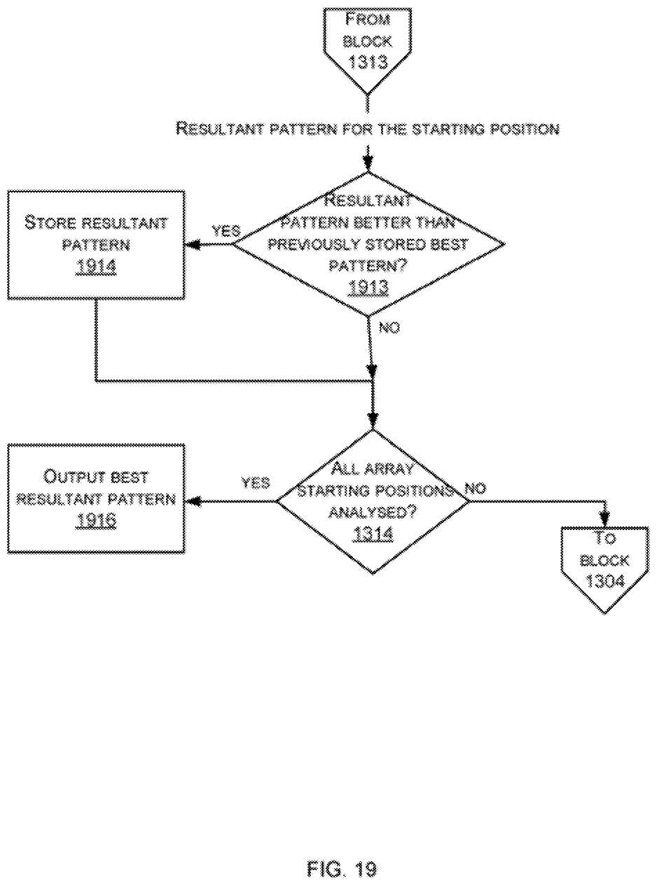

Whilst FIG. 13A shows the generation of all the resultant patterns before an assessment is performed to identify the best resultant pattern (in block 1316), in a variation of the end of this method shown in FIG. 19, the assessment may be performed each time a new resultant pattern is generated for a new starting position (in block 1313). As shown in FIG. 19, once a new resultant pattern is generated, it is determined whether that resultant pattern is better than a previously stored best resultant pattern (block 1913). This assessment (in block 1913) uses the same criteria as described above (with reference to block 1316) and it will be appreciated that for the first starting position to be considered for a spray window, there will be no previously stored best resultant pattern and so the result of this assessment will be ‘Yes’. If the newly generated resultant pattern is better than a previously stored best resultant pattern (‘Yes’ in block 1913) then the newly generated resultant pattern is stored in place of the previously stored pattern (block 1914) but if it is not better (‘No’ in block 1913) it is not stored.

The method then proceeds to determine whether all starting positions of been analysed (in block 1314) and the method is repeated if necessary. Once all array starting positions have been analysed (‘Yes’ in block 1314), then the stored best resultant pattern is output (block 1916). By using the method of FIG. 19, only one resultant pattern need be stored and the comparison is simplified to a comparison of two resultant patterns (the current best one and the new one) which results in a faster comparison.

In a variation of that shown in FIG. 19 and described above, instead of storing on a single resultant pattern, each resultant pattern may be stored but the one currently considered to be the best resultant pattern is tagged as being the best. This tagged resultant pattern is then used in the comparison (in block 1913) to determine whether to tag the newly created resultant pattern (if it is better) and remove the tag from the current tagged pattern, or whether not to tag the newly created resultant pattern (if it is not better than the current tagged pattern).

The variation shown in FIG. 19 may also be applied to the method of FIG. 13B so that instead of generating array portions for all starting positions for a target object before identifying the best array portion, the assessment is performed each time a new array portion (at a new starting position) is generated.

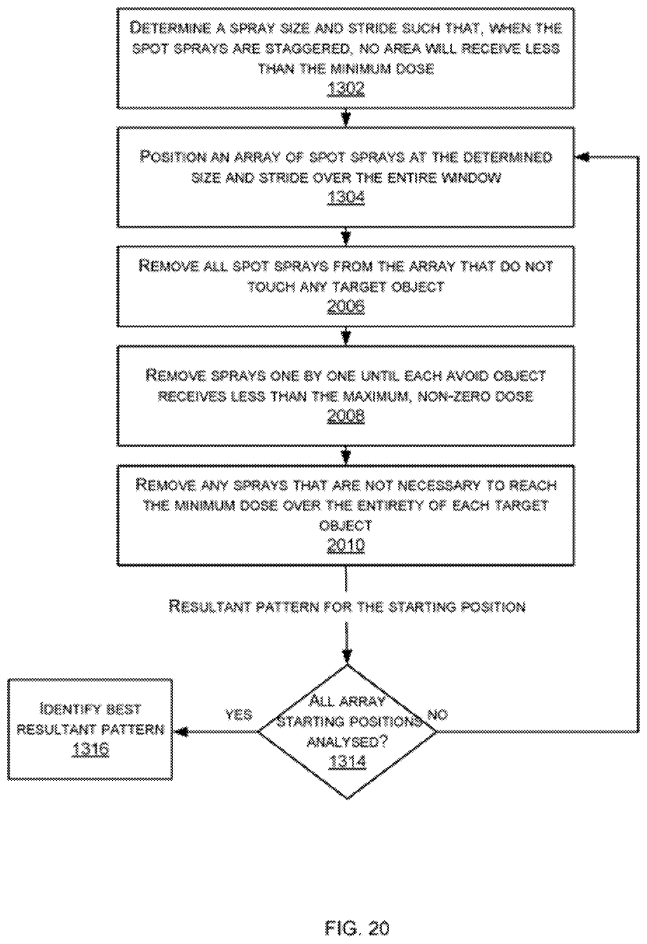

In the methods of FIGS. 13A and 19, array portions are generated for each target object and then combined (in block 1313). In contrast, in FIG. 20, which shows a further example method of defining a pattern of spot sprays that satisfies the criteria detailed above (in block 804), all the target objects are considered at the same time. This means that the method of FIG. 20 generates the resultant pattern for a starting position without first generating array portions for each target object.

As shown in FIG. 20, the method starts in the same way as FIGS. 13A and 19 (blocks 1302-1304), but when performing the removal steps (blocks 2006-2010), all target objects and all avoid objects are considered. As shown in FIG. 20, all spot sprays that do not touch any target object are removed (block 2006). Spot sprays are then removed one by one until the avoid objects each receive less than the maximum, non-zero, dose (block 2008) and also any spot sprays that are not necessary to reach the minimum dose on any of the target objects are removed (block 2010).

Having generated the resultant pattern for the starting position in this way, the method then proceeds as described above with reference to FIG. 13.

The modifications shown in FIG. 12A or 12B and described above may also be applied to the methods shown in FIGS. 13A, 13B and 19. The modification shown in FIG. 19 and described above may also be applied to the method shown in FIG. 20 (with the input to block 1913 being from block 2010).

Whilst FIGS. 13A, 13B and 20 show the different starting positions being analysed in sequence, it will be appreciated that in a variation of the methods shown, all of the starting positions may be analysed in parallel to enable the best solution to be identified (in block 1316).

By using the methods described above, the efficiency and adaptability of the spot spraying is increased. By more careful control of the agrochemicals delivered to the target object, the overall amount of agrochemicals sprayed can be reduced, thereby improving efficiency and effectiveness and reducing the environmental impact of both the use of the agrochemicals and their fabrication and transport.

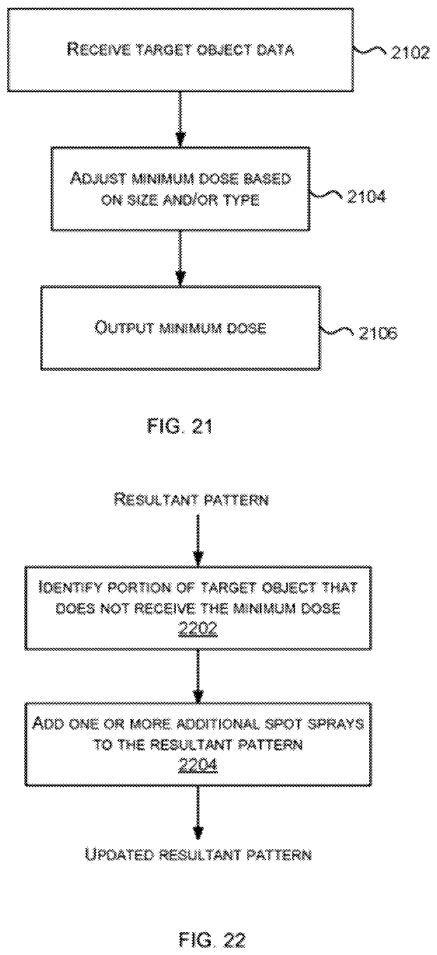

The minimum dose that is used may be fixed or variable and may be provided as an input to the methods described above. In some examples, the spot spray control system 102 may determine the minimum dose that is used by the methods described above based on data received from the imaging system 106. Alternatively, this determination may be performed by the imaging system 106 and the result input to the spot spray control system 102. As shown in FIG. 21, target object data is received (block 2102). Where the method is performed by the spot spray control system 102, this data is received from the imaging system 106. Based on the data received, a pre-defined minimum dose may either be adjusted or selected from a plurality of candidate pre-defined minimum doses, based on the size of the target object and/or the type of the target object (block 2104).

The resulting minimum dose is then output (block 2106) for use in the methods described above. The maximum, non-zero, dose may be provided as an input to the methods described above or determined using a corresponding method to that shown in FIG. 21.

The minimum and/or maximum doses may be increased (in block 2104) for larger target objects, where the size of a target object may refer to its area and/or its height (i.e. how tall it is). In addition, or instead, the minimum and/or maximum doses may be dependent upon the type of plant that is the target object.

By adjusting the minimum and/or maximum doses based on the size and/or type, the dose applied to target and/or avoid objects is tailored to the particular object and the overall effectiveness and/or efficiency of the application of agrochemicals can be increased.

In the methods described above, many of the criteria involve ensuring that all parts of the target object receive at least a pre-defined minimum dose. In a variation of the methods described above, the criteria may be modified so that at least a minimum proportion of the target object (e.g. at least 90% of the target object) receives the pre-defined minimum dose.

Where the minimum dose criteria is relaxed such that the resultant pattern does not guarantee that the entirety of the target objects receive at least the minimum dose, but instead that at least a pre-defined minimum proportion of the target objects receive at least the minimum dose, the resultant pattern that is generated using the methods of any of FIGS. 9, 12A, 12B, 13A, 13B, 19 and 20 may be supplemented with additional spot sprays as shown in FIG. 22. As shown in FIG. 22, portions of a target object that does not receive the minimum dose according to the resultant pattern are identified (block 2202) and then one or more additional spot sprays are added to the resultant pattern so that all areas of the target object receive the minimum dose (block 2204). This generates an updated resultant pattern which is then used to generate the control signals (in block 806 of FIG. 8).

The additional spot sprays that are added (in block 2204) may be of a different size to those in the input resultant pattern, e.g. they may be smaller. In addition, or instead, the spot sprays may be positioned at lateral and/or transverse offsets which are different from those used to generate the array of spot sprays (in block 1304). These additional spot sprays do not form a regular pattern and may be used to infill ‘holes’ in the resultant pattern that is generated using the methods of any of FIGS. 9, 12A, 12B, 13A, 13B, 19 and 20.

The methods described above may be performed for each spray window and as described above, spray windows may be contiguous or may partially overlap. When a spray pattern is bigger in the forward direction than a spray window, for instance a large target object (such as a patch of dense weeds) must be sprayed, then the spot placement pattern chosen in the first window (e.g. using the method of FIG. 8) will be preferably continued in the second window and the spots located at the bottom of the first window will serve as reference for the placement of the spots that need to be successively added in the second window. Referring back to the methods described above, this means that where different starting positions are analysed, the starting position selected for a first spray window is automatically selected for a second spray window where a target object extends from the first window into the second spray window. Referring back to FIGS. 13A, 13B, 19 and 20, this means that for the second spray window, only a single starting position is analysed and that starting position is the starting position that was used in the immediately previous first spray window. Furthermore, where the method of FIG. 20 is used, the same spray size and stride is used for the array of spot sprays (as position in block 1304) for both the first spray window and the second spray window.

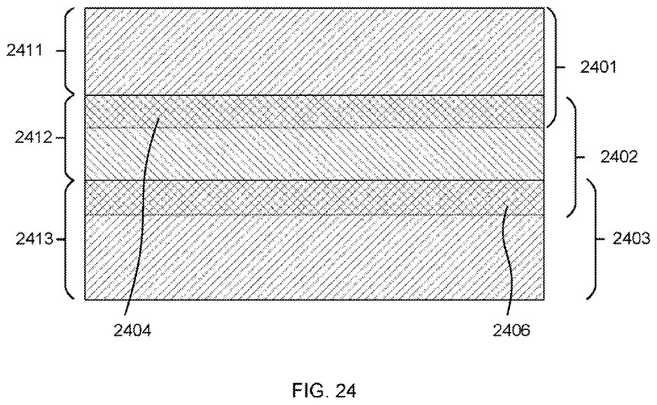

FIG. 24 shows three partially overlapping spray windows 2401-2403. Where spray windows partially overlap, as shown in FIG. 24, the methods described above may performed based on a modified spray window where the modified spray window excludes the portion of the spray window that overlaps with a next spray window. This means, that the methods described above are initially performed for the first modified spray window 2411 which comprises the first spray window 2401 but excluding the overlap portion 2404 with the second spray window 2402. By performing the methods described above in this way, the control signals are first generated (in block 806) and output for the first modified spray window 2411. The methods are then repeated to generate the control signals for the next modified spray window 2412 which comprises the second spray window 2402 including the overlap portion 2404 with the immediately previous spray window (spray window 2401) but excluding the overlap portion 2406 with the next spray window, the third spray window 2403. This is then repeated for all subsequent spray windows, where for each spray window, the portion that overlaps with the preceding window is considered whereas the portion that overlaps with the next window is excluded. As described above, where a target object extends from one modified spray window into the next modified spray window, the placement follows the same pattern in both modified spray windows (e.g. the same starting position is used and where the method of FIG. 20 is used, the same spray size and stride are used for the array).

The methods described above may be implemented by a spot spray control system, such as the spot spray control system 102 shown in FIG. 1. The spot spray control system may be implemented by one or more processors. The one or more processors can be programmable (e.g., a central processing unit (CPU) or a microcontroller), a field programmable gate array (FPGA), DSP, ASICs, PLC and/or one or more ARM processors, etc.

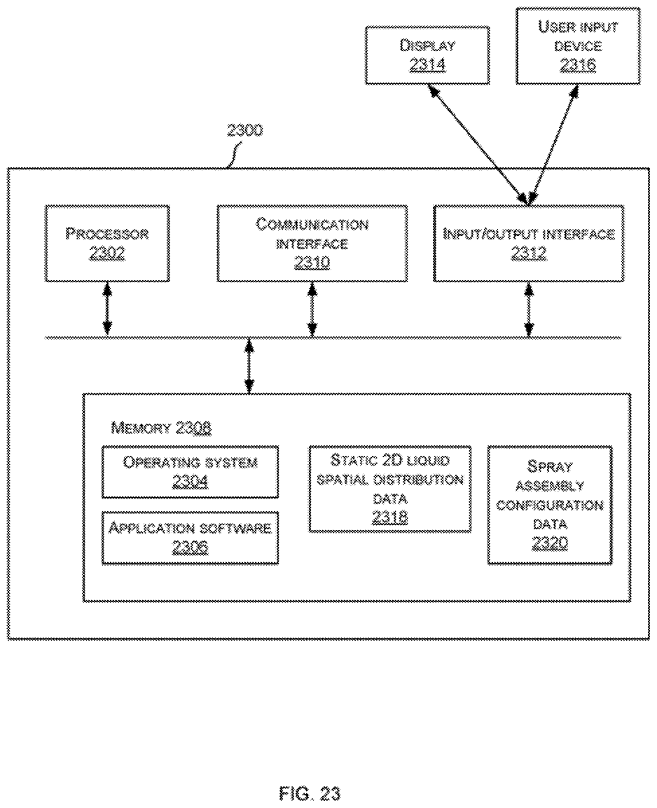

FIG. 23 illustrates various components of an example spot spray control system in the form of a computing-based device 2300. As described above, this computing-based device may also perform some of the functionality of the distance detection unit 108 and imaging system 106 shown in FIG. 1.

Computing-based device 2300 comprises one or more processors 2302 which may be microprocessors, controllers or any other suitable type of processors for processing computer executable instructions to control the operation of the device in order to perform the methods described herein (e.g. as shown in FIGS. 8, 9, 12A, 12B, 13A, 13B and 19-22). In some examples, for example where a system on a chip architecture is used, the processors 2302 may include one or more fixed function blocks (also referred to as accelerators) which implement a part of the method of controlling a spot spray system in hardware (rather than software or firmware). Platform software comprising an operating system 1804 or any other suitable platform software may be provided at the computing-based device to enable application software 2306, such as software that implements the methods described herein, to be executed on the device.

The computer executable instructions may be provided using any computer-readable media that is accessible by computing-based device 2300. Computer-readable media may include, for example, computer storage media such as memory 2308 and communications media. Computer storage media, such as memory 2308, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 1808) is shown within the computing-based device 2300 it will be appreciated that the storage may be distributed or located remotely and accessed via a network or other communication link (e.g. using communication interface 2310).

The communication interface 2310 may be arranged to receive data used in the methods described herein such as motion data (e.g. from vehicle 206 shown in FIG. 2 or from a sensor within the spot spray system), target object data (e.g. from the imaging system 106) and height data (e.g. from the distance detection unit 108). The communication interface 2310 may also be arranged out output the generated control signals (e.g. to the electromechanical valves 114 in the spray assembly 104).

The computing-based device 2300 may also comprises an input/output interface 2312 arranged to output display information to a display device 2314 which may be separate from or integral to the computing-based device 1800. For example, a display device 2314 may be attached to the body 204 of the spot spraying system 200 shown in FIG. 2 or positioned in the vehicle 206. In addition, or instead, the display information may be output via the communication interface 2310 to a remote display device 1814 (in a monitoring location that is remote from the spot spray system). The display information may provide a graphical user interface. The input/output interface 2312 may also be arranged to receive and process input from one or more devices, such as a user input device 1816 (e.g. one or more buttons on the body 204 of the spot spraying system 200 shown in FIG. 2 or positioned in the vehicle 206). This user input may be used to adjust parameters of the method or provide inputs, such as the pre-defined minimum and/or maximum dose. In an embodiment the display device 2314 may also act as the user input device 2316 if it is a touch sensitive display device. In some examples the input/output interface 2312 may be arranged to output the generated control signals (e.g. to the electromechanical valves 114 in the spray assembly 104) instead of, or in addition to, the communication interface 2310.

The memory 2308 may be arranged to store data used by the methods described herein, such as the static 2D liquid spatial distributions 2318 and configuration data for the spray assembly 2320 (e.g. nozzle spacing). The memory 2308 may be arranged to store the look-up tables described above and the resultant patterns generated using the methods described above.

Whilst FIG. 23 shows a single computing device that may be implemented locally within the spot spray system 100, 200 shown in FIGS. 1 and 2, in other examples some of the processing and/or data storage may be implemented remotely from the spray assembly, e.g. on a remote computing device that may be located in a data center or elsewhere. For example, the static 2D liquid spatial distributions 2318 and/or configuration data for the spray assembly 2320 may be stored remotely and accessed via the communication interface 2310. In addition or instead, the determination of the resultant patterns may be performed by a remote computing device and control signals received by the spray system via the communication interface 2310. In other examples, the processing and/or data storage may be split in a different way between a local computing device proximate to the spray assembly and a remote computing device (or plurality of local computing devices, e.g. where the data processing is performed on a different computing device to the data storage).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of operation of a spot spray control system for spraying agrochemicals on target objects using a spray assembly and minimising spraying on avoid objects, the spray assembly comprising an array of nozzles wherein an opening time and opening duration of the nozzles can be individually controlled and the method comprising:
(i) identifying a target object and a proximate avoid object;
(ii) defining by their placement and opening duration, a pattern of spot sprays such that a maximum, non-zero, dose applied to the proximate avoid object is not exceeded and at least a minimum dose per unit area is applied to a pre-defined proportion of the target object, wherein each spot spray is defined by a non-homogeneous two-dimensional liquid spatial distribution modified by a distance from the nozzle to the target object, a forward speed of the spray assembly and the opening duration of the nozzle;
(iii) generating control signals for the array of nozzles according to the pattern of spot sprays; and
(vi) outputting the control signals to the spray assembly.

2. The method according to claim 1, wherein defining the pattern of spot sprays comprises, for each target object:
placing a first spot spray as close as possible to the proximate avoid object without exceeding the maximum, non-zero, dose on the proximate avoid object;
placing one or more additional spot sprays as close as possible to the proximate avoid object to form a continuous spray region of at least the minimum dose over a part of the target object whilst not exceeding the maximum, non-zero, dose on the proximate avoid object; and
if the part of the target object covered by the continuous spray region is less than the pre-defined proportion of the target object, placing one or more further spot sprays such that the continuous spray region of at least the minimum dose extends over the pre-defined proportion of the target object.

3. The method according to claim 1, wherein defining the pattern of spot sprays comprises:
determining a spray size and stride such that when the spot sprays are staggered, no area will receive less than the minimum dose;
generating a plurality of resultant patterns, each resultant pattern corresponding to a different one of a plurality of a plurality of candidate starting positions for an array of spot sprays; and
selecting a resultant pattern from the plurality of resultant patterns that minimizes wastage of agrochemicals,
wherein each resultant pattern is generated by:
for each target object, generating an array portion by:
positioning an array of spot sprays at the determined size and stride over an entire spray window, starting at the candidate starting position;
removing all spot sprays from the array that do not touch the target object;
removing spot sprays until the proximate avoid object receives less than the maximum, non-zero dose; and
removing any spot sprays that are not necessary to reach the minimum dose over the pre-defined proportion of the target object;
and
combining the array portions for each of the target objects.

4. The method according to claim 1, wherein defining the pattern of spot sprays comprises:
determining a spray size and stride such that when the spot sprays are staggered, no area will receive less than the minimum dose; and
for each target object, generating a plurality of array portions, each array portion corresponding to a different one of a plurality of a plurality of candidate starting positions for an array of spot sprays; and
selecting an array portion from the plurality of array portions that minimizes wastage of agrochemicals,
wherein each array portion is generated by:
positioning an array of spot sprays at the determined size and stride over an entire spray window, starting at the candidate starting position;
removing all spot sprays from the array that do not touch the target object;
removing spot sprays until the proximate avoid object receives less than the maximum, non-zero dose; and
removing any spot sprays that are not necessary to reach the minimum dose over the pre-defined proportion of the target object.

5. The method according to claim 1, wherein the maximum, non-zero, dose is a maximum, non-zero, dose per unit area.

6. The method according to claim 2, further comprising:
determining whether there is more than one target object proximate to an avoid object; and
in response to determining that there is more than one target object proximate to an avoid object, dividing a maximum, non-zero overall dose for the avoid object into an allocation for each target object, wherein the allocation is the maximum, non-zero dose used when defining the pattern for the target object.

7. The method according to claim 2, further comprising:
determining whether there is more than one target object proximate to an avoid object;
in response to determining that there is more than one target object proximate to an avoid object, determining whether a maximum, non-zero overall dose for the avoid object gives a higher dose per unit area than a local maximum, non-zero dose per unit area for the avoid object; and
in response to determining that the maximum, non-zero overall dose for the avoid object does not give a higher dose per unit area than a local maximum, non-zero dose per unit area for the avoid object, dividing a maximum, non-zero overall dose for the avoid object into an allocation for each target object, wherein the allocation is the maximum, non-zero dose used when defining the pattern for the target object.

8. The method according to claim 1, wherein defining the pattern of spot sprays comprises:
determining a spray size and stride such that when the spot sprays are staggered, no area will receive less than the minimum dose;
generating a plurality of resultant patterns, each resultant pattern corresponding to a different one of a plurality of a plurality of candidate starting positions for an array of spot sprays; and
selecting a resultant pattern from the plurality of resultant pattern that minimizes wastage of agrochemicals,
wherein each resultant pattern is generated by:
positioning an array of spot sprays at the determined size and stride over an entire spray window, starting at the candidate starting position;
removing all spot sprays from the array that do not touch any target object;
removing spot sprays until each proximate avoid object receives less than the maximum, non-zero dose; and
removing any spot sprays that are not necessary to reach the minimum dose over the pre-defined proportion of any of the target objects;
and
combining the array portions for each of the target objects.

9. The method according to claim 1, wherein the pre-defined proportion of the target object is less than all of the target object and the method further comprising:
identifying a portion of the target object that does not receive the minimum dose; and
updating the pattern of spot sprays by adding one or more additional spot sprays over the portion of the target object.

10. The method according to claim 1, wherein the pre-defined proportion of the target object is all of the target object.

11. The method according to claim 1, wherein the two-dimensional liquid spatial distribution for a spot spray is determined based on a static two-dimensional liquid spatial distribution for a nozzle and received motion data for the spray assembly.

12. The method according to claim 1, wherein the two-dimensional liquid spatial distribution for a spot spray is determined based on a static two-dimensional liquid spatial distribution for a nozzle and a detected distance between the nozzle and the target object.

13. The method according to claim 1, wherein the two-dimensional liquid spatial distribution for a spot spray is determined based on a static two-dimensional liquid spatial distribution for a nozzle and an opening duration of the nozzle.

14. The method according to claim 11, wherein the two-dimensional liquid spatial distribution for a spot spray is defined in a look-up table.

15. The method according to claim 11, wherein the two-dimensional liquid spatial distribution for a spot spray is defined using a mathematically defined distribution.

16. The method according to claim 1, further comprising adjusting an opening duration of a nozzle to maintain a constant two-dimensional liquid spatial distribution for a spot spray in response to changes in forward speed of the nozzle during spraying.

17. The method according to claim 1, further comprising adjusting the pre-defined minimum dose based on a size or type of the target object.

18. A computer program comprising instructions which, when the program is executed by a computer, cause the computer to carry out a method of operation of a spot spray control system for spraying agrochemicals on target objects using a spray assembly and minimising spraying on avoid objects, the spray assembly comprising an array of nozzles wherein an opening time and opening duration of the nozzles can be individually controlled and the method comprising:
(i) identifying a target object and a proximate avoid object;
(ii) defining by their placement and opening duration, a pattern of spot sprays such that a maximum, non-zero, dose applied to the proximate avoid object is not exceeded and at least a minimum dose per unit area is applied to a pre-defined proportion of the target object, wherein each spot spray is defined by a non-homogeneous two-dimensional liquid spatial distribution modified by a distance from the nozzle to the target object, a forward speed of the spray assembly and the opening duration of the nozzle;
(iii) generating control signals for the array of nozzles according to the pattern of spot sprays; and
(vi) outputting the control signals to the spray assembly.

19. A computer-readable medium having stored thereon the computer program of claim 18.

20. A spot spray control system for spraying agrochemicals using a spray assembly, the spray assembly comprising an array of nozzles wherein an opening time and opening duration of the nozzles can be individually controlled and the spot spray control system comprising:
a processor;
one or more interfaces configured to receive target object data and output control signals to the spray assembly; and
memory arranged to store a computer program which, when executed by the processor, causes the control system to:
(i) identify a target object and a proximate avoid object;
(ii) define by their placement and opening duration, a pattern of spot sprays such that a maximum, non-zero, dose applied to the proximate avoid object is not exceeded and at least a minimum dose per unit area is applied to a pre-defined proportion of the target object, wherein each spot spray is defined by a non-homogeneous two-dimensional liquid spatial distribution modified by a distance from the nozzle to the target object, a forward speed of the spray assembly and the opening duration of the nozzle;
(iii) generate control signals for the array of nozzles according to the pattern of spot sprays; and
(vi) output the control signals to the spray assembly.
